(19) United States
(12) Patent Application Publication
(10) Pub. No.: US 2014/0082313 A1
(43) Pub. Date: Mar. 20, 2014

(54) STORAGE CLASS MEMORY EVACUATION

(71) Applicants: Robert Miller, JR., Poughkeepsie, NY (US); Harris M. Morgenstern, Poughkeepsie, NY (US); Walter W. Otto, Poughkeepsie, NY (US); Steven M. Partlow, Beacon, NY (US); Thomas F. Rankin, Wallkill, NY (US); Elpida Tzortzatos, LaGrangeville, NY (US)

(72) Inventors: Robert Miller, JR., Poughkeepsie, NY (US); Harris M. Morgenstern, Poughkeepsie, NY (US); Walter W. Otto, Poughkeepsie, NY (US); Steven M. Partlow, Beacon, NY (US); Thomas F. Rankin, Wallkill, NY (US); Elpida Tzortzatos, LaGrangeville, NY (US)

(73) Assignee: INTERNATIONAL BUSINESS MACHINES CORPORATION, Armonk, NY (US)

(21) Appl. No.: 13/616,405

(22) Filed: Sep. 14, 2012

(51) Int. Cl. G06F 12/08

(52) U.S. Cl. 711/166; 711/E12.022

(57) ABSTRACT

Embodiments relate to methods, systems and computer program products for evacuating a portion of a storage class memory. Upon receiving a request to evacuate the portion of the storage class memory a determination is made if the requested evacuation will result in a storage shortage. Based upon determining that the requested evacuation will not result in a storage shortage, the portion of the storage class memory is initialized for evacuation. After initialization is complete, evacuation of the plurality of address spaces of the portion of the storage class memory is preformed, wherein one or more of the plurality of address spaces are evacuated in parallel.

### BACKGROUND

The present invention relates generally to management of memory resources, and more specifically, to the evacuation of storage class memory.

The process of selecting which memory pages to displace from central storage and transfer to auxiliary storage is called page stealing, or page replacement. Pages of memory stored in real storage may need to be transferred to storage class memory depending on real storage usage patterns and the need for real storage by critical or high priority work. The pool of memory available to the system may include a mixture of direct access storage devices (DASD) and storage class memory devices, such as flash memory for storing paging data sets. Furthermore, these DASDs may be configured for use with a single system or shared between two or more systems.

Many operating systems support an operator command to take offline a DASD, or a portion thereof, or some other type of external media used for paging. Typically, taking a DASD, or a portion thereof offline is performed in the context of system maintenance. In one current approach when a DASD is taken offline an auxiliary storage manager, which manages the storage class memory, copies the pages in the data set of the DASD being taken offline to another online location and builds a conversion table to translate the IDs (referred to as LSIDs) of slots on the old page data set to blocks on the new one. One down side of this scheme is scalability, as the size of the conversion table grows linearly with the number of pages that need to be copied.

Another technique that has been used to take a DASD offline is to search every dynamic address translation (DAT) table in the system for all of the slots associated with the DASD being removed. When such a reference is encountered, the page is copied into the real memory and the slot identifier is freed. Performing a complete DAT table search for every slot identifier requires substantial processor resources and can take a long time. Additionally, once the data has been copied into the real memory, no attempt is made to evict the data out to another DASD, which may cause the process to fail if there is insufficient real memory available.

### SUMMARY

Embodiments include a computer system for evacuating a portion of a storage class memory. The system includes a real storage manager configured to control a real memory and an auxiliary storage manager in communication with the real storage manager, the auxiliary storage manager configured to control one or more direct access storage devices and the storage class memory, the portion of the storage class memory including a plurality of address spaces, the system configured to perform a method. The method includes receiving a request to evacuate the portion of the storage class memory and determining if requested evacuation will result in a storage shortage. Based upon determining that the requested evacuation will not result in a storage shortage, the method includes initializing the portion of the storage class memory for evacuation and performing evacuation of the plurality of address spaces of the portion of the storage class memory, wherein one or more of the plurality of address spaces are evacuated in parallel.

Embodiments also include a computer implemented method for evacuating a portion of a storage class memory. The method includes receiving a request to evacuate the portion of the storage class memory and determining if requested evacuation will result in a storage shortage. Based upon determining that the requested evacuation will not result in a storage shortage, the method includes initializing the portion of the storage class memory for evacuation and performing evacuation of the plurality of address spaces of the portion of the storage class memory, wherein one or more of the plurality of address spaces are evacuated in parallel.

Embodiments further include a computer program product for evacuating a portion of a storage class memory, the computer program product including a tangible storage medium readable by a processing circuit and storing instructions for execution by the processing circuit for performing a method. The method includes receiving a request to evacuate the portion of the storage class memory and determining if requested evacuation will result in a storage shortage. Based upon determining that the requested evacuation will not result in a storage shortage, the method includes initializing the portion of the storage class memory for evacuation and performing evacuation of the plurality of address spaces of the portion of the storage class memory, wherein one or more of the plurality of address spaces are evacuated in parallel.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as embodiments is particularly pointed out and distinctly claimed in the claims at the conclusion of the specification. The forgoing and other features, and advantages of the embodiments are apparent from the following detailed description taken in conjunction with the accompanying drawings in which:

FIG. 1 illustrates a block diagram of a system in accordance with an exemplary embodiment;

FIG. 2 depicts a block diagram of system for evacuation of storage class memory in accordance with an exemplary embodiment;

FIG. 3 depicts a process flow for a method of performing evacuation of a portion of storage class memory in accordance with exemplary embodiment;

FIG. 4 depicts a process flow for a method for evacuating the address spaces of a portion of the storage class memory in accordance with exemplary embodiments; and

FIG. 5 depicts a process flow for a method for evacuating an address space in accordance with exemplary embodiment.

### DETAILED DESCRIPTION

In exemplary embodiments, a method for performing storage class memory evacuation uses multiple threads, which are each assigned to different address spaces, to evacuate the data from the different address spaces concurrently. Rather than repeatedly searching every DAT structure in the system for each blockid being configured offline the auxiliary storage manager provides a call back function to the threads performing the evacuation so that they can ask the auxiliary storage manager whether a blockid is being configured offline. By using this technique, normally only a single pass is required for each address space. In exemplary embodiments, the method for performing storage class memory evacuation may also attempt to evict pages that were copied into real storage to other online storage class memory.

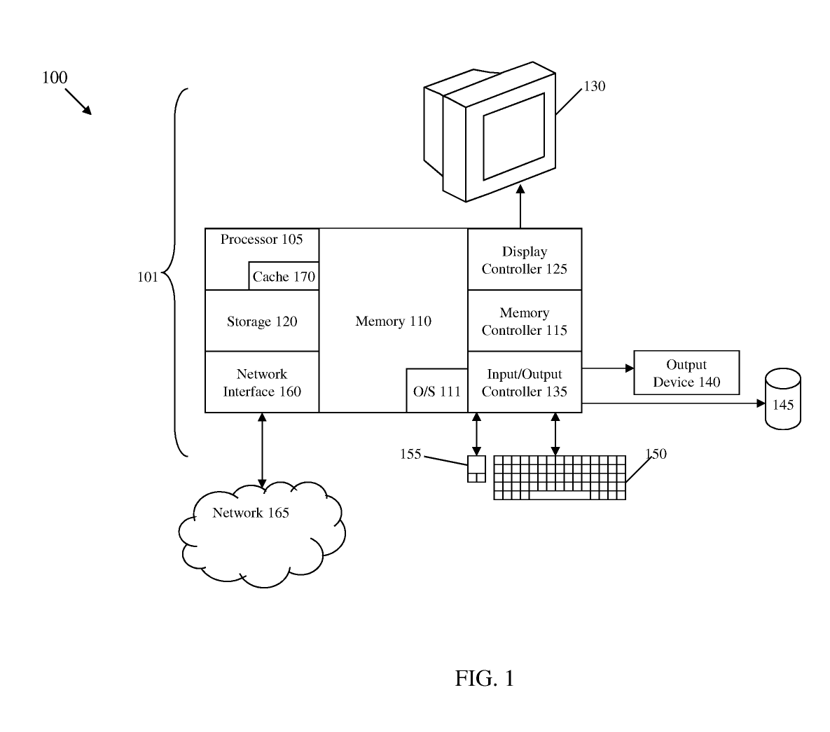

FIG. 1 illustrates a block diagram of an exemplary computer system 100 for use with the teachings herein. The methods described herein can be implemented in hardware software (e.g., firmware), or a combination thereof. In an exemplary embodiment, the methods described herein are implemented in hardware, and is part of the microprocessor of a special or general-purpose digital computer, such as a personal computer, workstation, minicomputer, or mainframe computer. The system 100 therefore includes general-purpose computer 101.

In an exemplary embodiment, in terms of hardware architecture, as shown in FIG. 1, the computer 101 includes a processor 105, memory 110 coupled via a memory controller 115, a storage device 120, and one or more input and/or output (I/O) devices 140, 145 (or peripherals) that are communicatively coupled via a local input/output controller 135. The input/output controller 135 can be, for example, but not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The storage device 120 may include one or more hard disk drives (HDD), solid state drives (SSD), or any other suitable form of storage.

The processor 105 is a computing device for executing hardware instructions or software, particularly that stored in memory 110. The processor 105 can be any custom made or commercially available processor, a central processing unit (CPU), an auxiliary processor among several processors associated with the computer 101, a semiconductor based microprocessor (in the form of a microchip or chip set), a macroprocessor, or generally any device for executing instructions. The processor 105 may include a cache 170, which may be organized as a hierarchy of more cache levels (L1, L2, etc.).

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 110 may incorporate electronic, magnetic, optical, and/or other types of storage media. Note that the memory 110 can have a distributed architecture, where various components are situated remote from one another, but can be accessed by the processor 105.

The instructions in memory 110 may include one or more separate programs, each of which comprises an ordered listing of executable instructions for implementing logical functions. In the example of FIG. 1, the instructions in the memory 110 include a suitable operating system (OS) 111. The operating system 111 essentially controls the execution of other computer programs and provides scheduling, input-output control, file and data management, memory management, and communication control and related services.

In an exemplary embodiment, a conventional keyboard 150 and mouse 155 can be coupled to the input/output controller 135. Other output devices such as the I/O devices 140, 145 may include input devices, for example but not limited to a printer, a scanner, microphone, and the like. Finally, the I/O devices 140, 145 may further include devices that communicate both inputs and outputs, for instance but not limited to, a network interface card (NIC) or modulator/demodulator (for accessing other files, devices, systems, or a network), a radio frequency (RF) or other transceiver, a telephonic interface, a bridge, a router, and the like. The system 100 can further include a display controller 125 coupled to a display 130. In an exemplary embodiment, the system 100 can further include a network interface 160 for coupling to a network 165. The network 165 can be an IP-based network for communication between the computer 101 and any external server, client and the like via a broadband connection. The network 165 transmits and receives data between the computer 101 and external systems. In an exemplary embodiment, network 165 can be a managed IP network administered by a service provider. The network 165 may be implemented in a wireless fashion, e.g., using wireless protocols and technologies, such as Wi-Fi, WiMax, etc. The network 165 can also be a packet-switched network such as a local area network, wide area network, metropolitan area network, Internet network, or other similar type of network environment. The network 165 may be a fixed wireless network, a wireless local area network (LAN), a wireless wide area network (WAN) a personal area network (PAN), a virtual private network (VPN), intranet or other suitable network system and includes equipment for receiving and transmitting signals.

If the computer 101 is a PC, workstation, intelligent device or the like, the instructions in the memory 110 may further include a basic input output system (BIOS) (omitted for simplicity). The BIOS is a set of essential routines that initialize and test hardware at startup, start the OS 111, and support the transfer of data among the storage devices. The BIOS is stored in ROM so that the BIOS can be executed when the computer 101 is activated.

When the computer 101 is in operation, the processor 105 is configured to execute instructions stored within the memory 110, to communicate data to and from the memory 110, and to generally control operations of the computer 101 pursuant to the instructions.

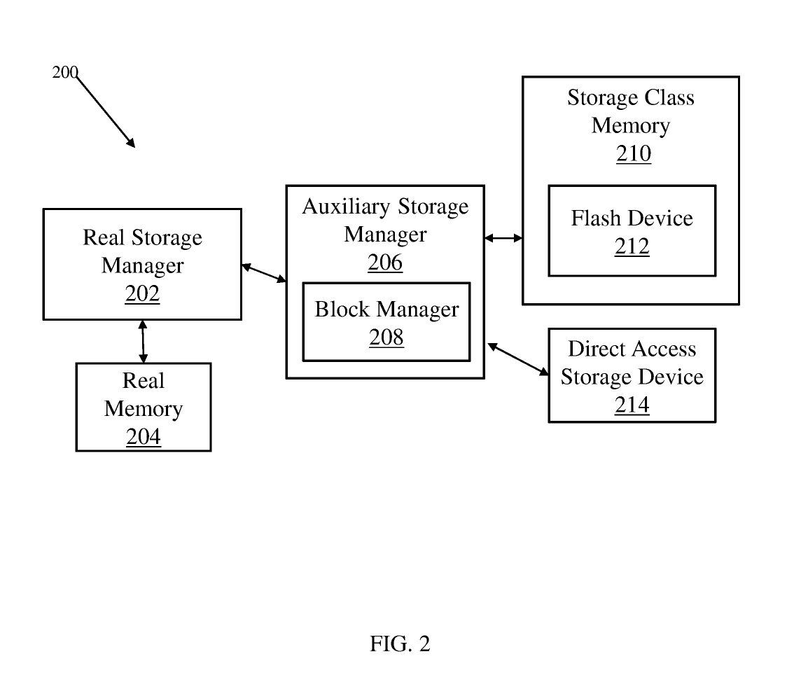

Referring now to FIG. 2, a block diagram of system 200 for evacuating storage class memory in accordance with an exemplary embodiment is shown. As illustrated, the system 200 includes a real storage manager 202 that is in communication with and configured to manage a real memory 204, also referred to as real storage. The system 200 also includes an auxiliary storage manager 206 that is in communication with and configured to manage a storage class memory 210 and one or more DASDs 214. In exemplary embodiments, the storage class memory 210 may include a variety of storage devices including, but not limited to, one or more flash devices 212.

In exemplary embodiments, the real storage manager 202 is configured to select a set of pages to evict from the real memory 204 and to call the auxiliary storage manager 206 to write content of the selected pages to the storage class memory 210. In exemplary embodiments, the block manager 208 of the auxiliary storage manager 206 is configured to choose a location in the storage class memory 210 to store the content of the selected pages. After selecting a location in the storage class memory 210, such as the flash device 212, the auxiliary storage manager 206 initiates an I/O operation to write the selected location. Upon completion of the I/O operation the auxiliary storage manager 206 notifies the real storage manager 202 that the I/O operation is complete. In exemplary embodiments, the block manger 208 of the auxiliary storage manager 206 is configured to keep track of the locations in the storage class memory 210 that the pages are written to, these locations are referred to as blockids.

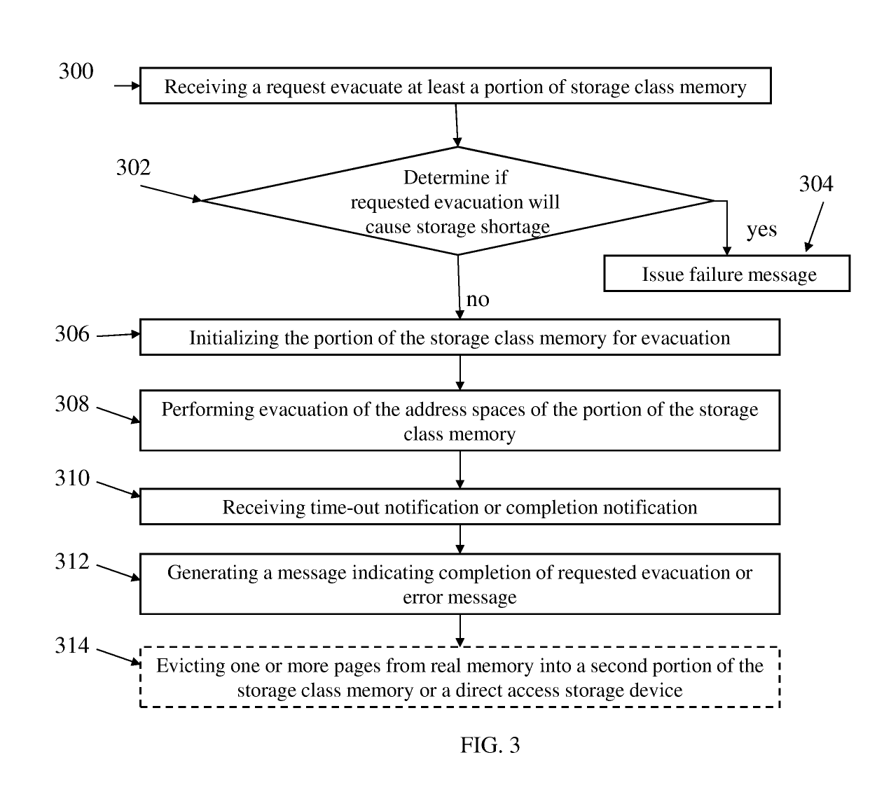

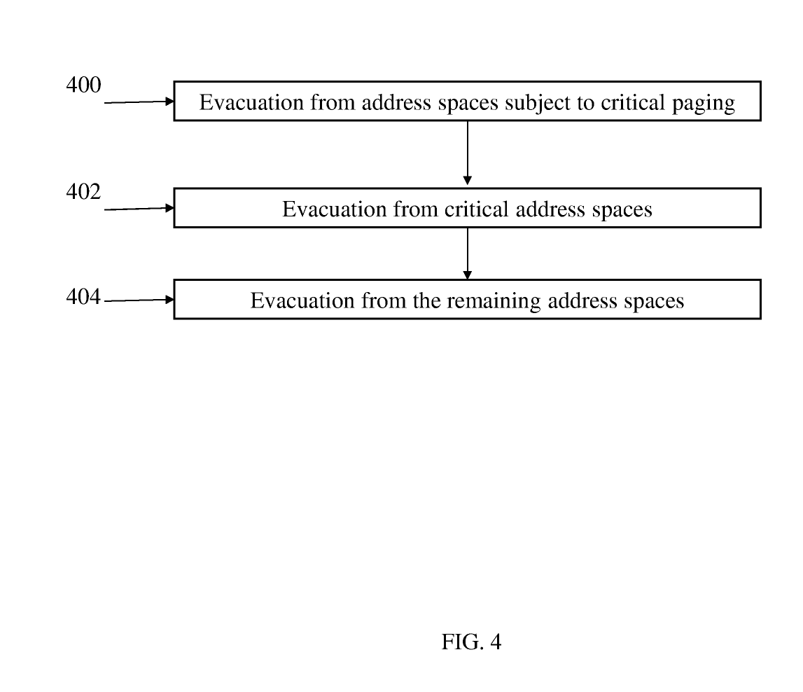

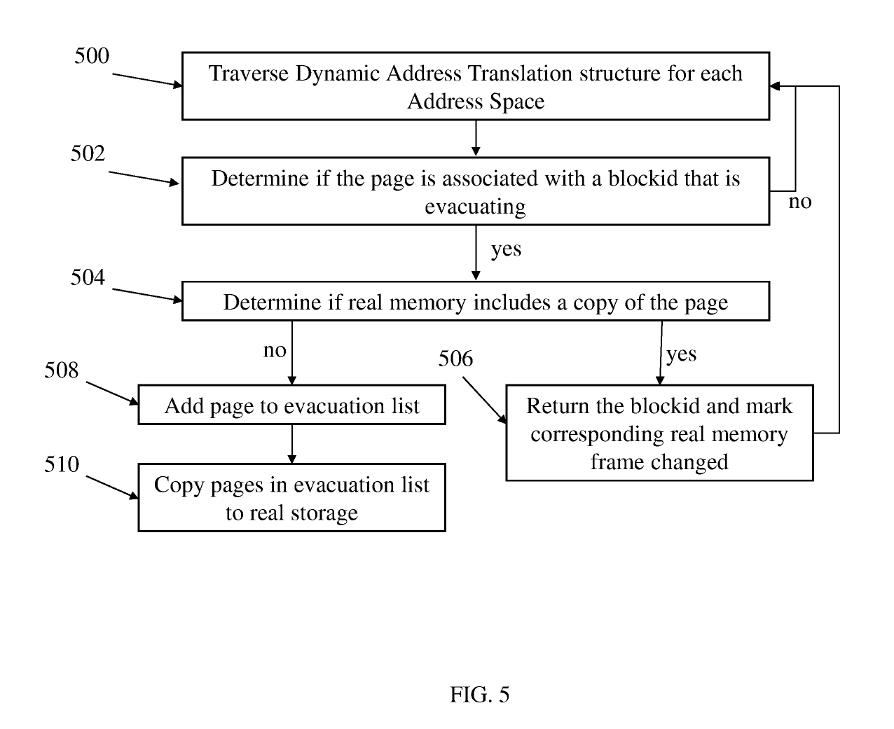

Referring now to FIG. 3, a process flow for a method of performing evacuation of a portion of storage class memory in accordance with exemplary embodiments is shown. As shown at block 300, the method begins with receiving a request evacuate at least a portion of a storage class memory. Next, as shown at block 302, the method includes determining if the requested evacuation will cause a storage shortage. For example, the real and/or auxiliary storage manager(s) may check to determine whether there will be sufficient paging resources available after the requested portion has been removed to accommodate all of the pages that will no longer be backed on the storage class memory portions being removed. If the requested evacuation will result in a storage shortage, the method proceeds to block 304 and a failure message is issued. Otherwise, the method proceeds to block 306 and the requested portion of the storage class memory is initialized for evacuation. In exemplary embodiments, initialization may include instructing the auxiliary storage manager to lock down the portion to be removed down so that no subsequent blockids may be distributed from that portion. Next, as shown at block 308, the method includes evacuating the address spaces of the portions of the storage class memory, as described in more detail with reference to FIGS. 4 and 5. At block 310, the method includes receiving either a time-out notification or completion notification indicating that the evacuation of the portion of the storage class memory has been completed. The method proceeds to block 312 by generating a message indicating completion of requested evacuation or error message. Optionally, the method may include evicting one or more pages from real memory into a second portion of the storage class memory that is not being evacuated or to a DASD, as shown at block 314.

In exemplary embodiments, once the auxiliary storage manager is aware that an evacuation is ongoing for a portion of the storage class memory the auxiliary storage manager will not reuse blockids associated with those portions for output I/O. In exemplary embodiments, the DAT traversal of address spaces does not begin until there is no output I/O in progress to blockids being evacuated. This allows the evacuation processing to ignore output I/O. Any output I/O initiated once evacuation begins is directed by the auxiliary storage manager to blockids that are NOT being configured offline. It is only output I/O that is initiated prior to the start of evacuation that is of concern and is handled by quiescing output I/O to the effected blockids at the start of evacuation. When all this is up front processing is complete, the evacuation of the storage class memory can begin by scheduling one or more threads to the real storage manager address space and waiting for either notification of success, failure or a time out.

Critical paging is associated with the notion of remote mirroring of DASD devices, whereby one DASD device can failover to its backup mirror device which may be a distance away from the primary device. The software that's involved in the failover to the mirror device cannot itself take a page fault on pages backed on the DASD device involved in the failover while processing the failover. The address spaces and storage areas associated with such software is “subject to critical paging” and therefore can never be paged out to DASD.

Referring now to FIG. 4, a process flow for a method for evacuating the address spaces of a portion of the storage class memory in accordance with exemplary embodiments is shown. As illustrated, evacuation of the portion of the storage class memory begins with evacuation of the address spaces that are subject to critical paging, as shown at block 400. In exemplary embodiments, a common address space and a shared storage address space are subject to critical paging. In exemplary embodiments, when a DASD paging device is being exchanged, the address spaces in the operating system that are involved in the failover cannot reference pages on the device and are therefor referred to as being subject to critical paging. Next, as shown at block 402, evacuation of the portion of the storage class memory proceeds with evacuation from critical address spaces from the storage class memory. In exemplary embodiments, critical address spaces can handle page faults in the face of a hyperswap failover, if the page is backed on storage class memory, but they cannot tolerate a page fault where the page resides on the volume being removed. Next, as shown at block 406, evacuation of the portion of the storage class memory proceeds with evacuation from the remaining address spaces. In exemplary embodiments, the order in which the address spaces are evacuated is selected to preserve the limited amount of storage class memory remaining for the address spaces that require it most, namely the ones subject to critical paging.

In exemplary embodiments, the evacuation of different address spaces may be configured to be performed in parallel by one or more threads, while maintaining the evacuation order described above. Address spaces may be split into multiple different address spaces that are each processed by a separate processing thread simultaneously. When a thread has completed storage evacuation for a particular address space, it determines whether additional threads need to be scheduled for address spaces that have not yet been processed. In exemplary embodiments, the level of concurrency may be based on the number of active processors, or processing cores, and the number of remaining address spaces. When all address spaces have been processed, the final thread indicates that the request has completed.

Referring now to FIG. 5, a process flow for a method for evacuating an address space in accordance with exemplary embodiments is shown. As illustrated at block 500, the method includes traversing a dynamic address translation (DAT) structure for each address space. Next, for each page in the DAT, a determination is made if the page is associated with a blockid that is evacuating, as shown at block 502. If the page is not associated with a blockid that is evacuating, the method returns to block 500 and continues to traverse the DAT. Otherwise, the method proceeds to block 504 and a determination is made if the real memory includes a copy of the page. If the real memory includes a copy of the page, the blockid is returned and the corresponding real memory frame is marked changed, as shown at block 506. If the real memory does not include a copy of the page, the page is not immediately copied into the real memory, but rather added to an evacuation list, as shown at block 508. Next, the pages included in the evacuation list are copied into the real memory in a batch I/O request, as shown at block 510. In exemplary embodiments, grouping of I/O requests increases the performance of the evacuation process as compared with initiating multiple I/O requests for each page one at a time. In exemplary embodiments, if a page is copied into real memory during evacuation, the page may be subsequently evicted back out to another portion of the storage class memory that is not being taken offline or to a DASD paging data set if the address space is not subject to critical paging. This reduces the likelihood of introducing a real frame shortage and allows for better availability in the sense that the evacuation process should minimize the impact on concurrent workloads.

In exemplary embodiments, storage class memory blockids may be transferred from one address space to another as part of regular mainline processing. The evacuation process may be configured to track the transfer of blockids by marking the address space that the blockid is being transferred to as requiring evacuation, if the transferred blockid is being evacuated. Accordingly, the address space being evacuated may be evacuated multiple times since the blockid transfer may occur after evacuation processing has already completed for the target address space, or while the address space was in the process of being evacuated.

In exemplary embodiments, the storage class memory evacuation process is also configured to handle cases where a page is in a transitional state, either input or output I/O in progress, when the page is evaluated to determine whether evacuation is necessary. In general, output I/O does not cause any issues because the block manager does not distribute any blockids from increments being evacuated and because output I/O is quiesced prior to initiating evacuation. For input I/O, the evacuation process suspends evacuation of the page for the I/O to complete and then reprocesses the page and because the evacuation processor waits for any evacuating blockids with output I/O in progress to complete before initiating evacuation.

When evacuation of all of the address spaces of the portion of the storage class memory being removed has completed successfully, there will be one active evacuation thread. The last thread waits for any virtually disconnected input I/O in progress for any blocks that are evacuating. Virtual disconnect refers to I/O that was initiated for a page whose state has changed. For example, the page was freed while input I/O was in progress due to a page fault. Such blockids would never be detected during a DAT traversal. The auxiliary storage manager's I/O queues must be searched for blockids that are evacuating and if a blockid that is evacuating has an active I/O, the search is delayed and repeated. Once no such blockids are detected, a bind-break is issued to ensure that I/O for any blockids that were not represented on any of auxiliary storage manager's queues will complete. A bind break is a facility which allows the invoker to ensure that all processors have enabled interrupts and therefore dropped the lock that serializes the auxiliary storage managers I/O queues once control returns to the invoker of the bind break. Other platforms have a similar interface for ensuring that all processors have released a lock if it were held at the point in time where the interface was invoked to the point where it completed. It should be noted that the same technique of combining a search of the auxiliary storage manager's I/O queues with a bind break occurred when the evacuation process began, except that the search was for output I/O instead of input I/O.

In exemplary embodiments. address space deletion and data space deletion are additional inhibitors to storage class memory reconfiguration since the evacuation process is not be able to traverse the DAT structures associated with these spaces. Accordingly, the evacuation process may be configured to ensure that no such asynchronous processing for these functions is ongoing before it notifies the command processor of successful evacuation.

In exemplary embodiments, after a portion of the storage class memory is evacuated the block manager checks to determine if all of the blockids were evacuated from the portion of the storage class memory. If the block manager detects that one or more blockids were not evacuated, the block manager copies the contents of these blockids to other blockids not being taken offline or to DASD and builds a conversion table. In exemplary embodiments, the conversion table is a hash table which provides a quick lookup to determine whether the data specified by the blockid can be found on some other location, either on storage class memory (blockid) or DASD (LSID). Once the blockids are copied and the conversion table built, the designated area of storage class memory can be taken offline. When one of the “converted” blockids is subsequently returned to block manager, its entry is removed from the conversion table. When a page fault occurs which requires input I/O from one of the “converted” blockids, upon I/O completion, the block manager indicates to the real storage manager the new location of the blockid. The real storage manager updates the location of the page in the DAT structures and the block manager removes the blockid from the conversion table.

As will be appreciated by one skilled in the art, one or more aspects of the present invention may be embodied as a system, method or computer program product. Accordingly, one or more aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system”. Furthermore, one or more aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code, when created and stored on a tangible medium (including but not limited to electronic memory modules (RAM), flash memory, Compact Discs (CDs), DVDs, Magnetic Tape and the like is often referred to as a “computer program product”. The computer program product medium is typically readable by a processing circuit preferably in a computer system for execution by the processing circuit. Such program code may be created using a compiler or assembler for example, to assemble instructions, that, when executed perform aspects of the invention.

The terminology used herein is for the purpose of describing particular embodiments only and is not intended to be limiting of embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments have been presented for purposes of illustration and description, but is not intended to be exhaustive or limited to the embodiments in the form disclosed. Many modifications and variations will be apparent to those of ordinary skill in the art without departing from the scope and spirit of the embodiments. The embodiments were chosen and described in order to best explain the principles and the practical application, and to enable others of ordinary skill in the art to understand the embodiments with various modifications as are suited to the particular use contemplated.

Computer program code for carrying out operations for aspects of the embodiments may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of embodiments are described above with reference to flowchart illustrations and/or schematic diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer system for evacuating a portion of a storage class memory, the system comprising:
a real storage manager configured to control a real memory;
an auxiliary storage manager in communication with the real storage manager, the auxiliary storage manager configured to control one or more direct access storage devices and the storage class memory, the portion of the storage class memory including a plurality of address spaces, the system configured to perform a method comprising:
receiving a request to evacuate the portion of the storage class memory;
determining whether requested evacuation will result in a storage shortage;
based upon determining that the requested evacuation will not result in a storage shortage:
initializing the portion of the storage class memory for evacuation; and
performing evacuation of the plurality of address spaces of the portion of the storage class memory, wherein one or more of the plurality of address spaces are evacuated in parallel.

2. The computer system of claim 1, wherein performing evacuation of one of the plurality of address spaces of the portion of the storage class memory further comprises:
traversing a dynamic address translation structure of the address space, wherein the dynamic address translation structure includes a plurality of pages each of which is associated with a blockid;
determining whether the blockid associated with each of the plurality of pages corresponds to an evacuating blockid;
based on determining that the blockid associated with one of the plurality of pages corresponds to the evacuating blockid; determining if the real memory includes the page; and
based on determining that the real memory does not include the page, adding the page to an evacuation list and copying the pages in the evacuation list into the real memory in a batch I/O operation.

3. The computer system of claim 2, wherein the plurality of address spaces incudes a critical address space and a non-critical address space.

4. The computer system of claim 3, wherein performing evacuation of the plurality of address spaces of the portion of the storage class memory includes evacuating the critical address space prior to evacuating the non-critical address space.

5. The computer system of claim 2, further comprising based on determining that the real memory includes the page, returning the blockid and marking a corresponding real memory frame changed.

6. The computer system of claim 2, further comprising:
evicting one or more of the pages copied into the real memory into a second portion of storage class memory that is not evacuated or one of the direct access storage devices.

7. The computer system of claim 1, wherein initializing the portion of the storage class memory for evacuation includes instructing the auxiliary storage manager not to distribute additional blockids from the portion of the storage class memory.

8. A computer implemented method for evacuating a portion of a storage class memory, the method comprising:
receiving, by a processor, a request to evacuate the portion of the storage class memory;
determining whether the requested evacuation will result in a storage shortage;
based upon determining that the requested evacuation will not result in a storage shortage:
initializing the portion of the storage class memory for evacuation; and
performing evacuation of the plurality of address spaces of the portion of the storage class memory, wherein one or more of the plurality of address spaces are evacuated in parallel.

9. The computer implemented method of claim 8, wherein performing evacuation of one of the plurality of address spaces of the portion of the storage class memory further comprises:
traversing a dynamic address translation structure of the address space, wherein the dynamic address translation structure includes a plurality of pages each of which is associated with a blockid;
determining whether the blockid associated with each of the plurality of pages corresponds to an evacuating blockid;
based on determining that the blockid associated with one of the plurality of pages corresponds to the evacuating blockid; determining whether the real memory includes the page; and
based on determining that the real memory does not include the page, adding the page to an evacuation list and copying the pages in the evacuation list into the real memory in a batch I/O operation.

10. The computer implemented method of claim 9, wherein the plurality of address spaces incudes a critical address space and a non-critical address space.

11. The computer implemented method of claim 10, wherein performing evacuation of the plurality of address spaces of the portion of the storage class memory includes evacuating the critical address space prior to evacuating the non-critical address space.

12. The computer implemented method of claim 9, further comprising based on determining that the real memory includes the page, returning the blockid and marking a corresponding real memory frame changed.

13. The computer implemented method of claim 9, further comprising:
evicting one or more of the pages copied into the real memory into a second portion of storage class memory that is not evacuated or one of the direct access storage devices.

14. The computer implemented method of claim 8, wherein initializing the portion of the storage class memory for evacuation includes preventing additional blockids from the portion of the storage class memory from being distributed.

15. A computer program product for evacuating a portion of a storage class memory, the computer program product comprising:
a tangible storage medium readable by a processing circuit and storing instructions for execution by the processing circuit for performing a method comprising:
receiving, by a processor, a request to evacuate the portion of the storage class memory;
determining whether the requested evacuation will result in a storage shortage;
based upon determining that the requested evacuation will not result in a storage shortage:
initializing the portion of the storage class memory for evacuation; and
performing evacuation of the plurality of address spaces of the portion of the storage class memory, wherein one or more of the plurality of address spaces are evacuated in parallel.

16. The computer program product of claim 15, wherein performing evacuation of one of the plurality of address spaces of the portion of the storage class memory further comprises:
traversing a dynamic address translation structure of the address space, wherein the dynamic address translation structure includes a plurality of pages each of which are associated with a blockid;
determining whether the blockid associated with each of the plurality of pages corresponds to an evacuating blockid;
based on determining that the blockid associated with one of the plurality of pages corresponds to the evacuating blockid; determining whether the real memory includes the page; and
based on determining that the real memory does not include the page, adding the page to an evacuation list and copying the pages in the evacuation list into the real memory in a batch I/O operation.

17. The computer program product of claim 16, wherein the plurality of address spaces incudes a critical address space and a non-critical address space.

18. The computer program product of claim 17, wherein performing evacuation of the plurality of address spaces of the portion of the storage class memory includes evacuating the critical address space prior to evacuating the non-critical address space.

19. The computer program product of claim 16, further comprising based on determining that the real memory includes the page, returning the blockid and marking a corresponding real memory frame changed.

20. The computer implemented method of claim 16, further comprising:
evicting one or more of the pages copied into the real memory into a second portion of storage class memory that is not evacuated or one of the direct access storage devices.
